(19) United States
(12) Patent Application Publication
(10) Pub. No.: US 2021/0286549 A1
(43) Pub. Date: Sep. 16, 2021

(54) VARIABLE WIDTH COLUMN READ OPERATIONS IN 3D STORAGE DEVICES WITH PROGRAMMABLE ERROR CORRECTION CODE STRENGTH

(71) Applicant: Intel Corporation, Santa Clara, CA (US)

(72) Inventors: Sourabh Dongaonkar, Portland, OR (US); Jawad Khan, Portland, OR (US)

(21) Appl. No.: 17/327,266

(22) Filed: May 21, 2021

(51) Int. Cl. G06F 3/06

(52) U.S. Cl. CPC G06F 3/0655; G06F 3/0604; G06F 3/0679; G06F 3/064

(57) ABSTRACT

Systems, apparatuses and methods may provide for technology that organizes data and corresponding parity information into a plurality of die words, distributes a column of the die words across a plurality of storage dies, and distributes the column across a plurality of partitions. In one example, the technology also reads a row of the die words at a read rate and reads the column of the die words at the read rate.

### TECHNICAL FIELD

Embodiments generally relate to memory structures. More particularly, embodiments relate to variable width column read operations in three-dimensional (3D) storage devices with programmable error correction code (ECC) strength.

### BACKGROUND

Three-dimensional (3D) memory may be arranged in a matrix that is multiple layers high, with rows and columns that intersect. In such a case, the intersections may include a microscopic material-based switch that is used to access a particular memory cell. A challenge in two-dimensional memory access is achieving error correction code (ECC) protection in both columns and rows, which may require extra space (e.g., for parity bits) and increase the complexity of the solution. Moreover, some solutions may offer a “one size fits all” ECC scheme, which might not be optimal for all use cases. Although proposed encoding schemes may allow existing ECC protection to be used in one direction (e.g., while relying on robust encoding in the other orthogonal direction for data protection), not all applications can be encoded efficiently and not all applications need a single-sized ECC strength.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a memory layout according to an embodiment;

FIG. 2 is an illustration of an example of a read rate that is common to rows and columns according to an embodiment;

FIG. 3 is a comparative illustration of an example of a conventional column of data and a column of data according to an embodiment;

FIGS. 4A-4D are illustrations of examples of initial row and column layouts according to an embodiment;

FIGS. 5A-5D are illustrations of examples of a distribution of the columns in FIGS. 4A-4D across a plurality of storage dies according to an embodiment;

FIGS. 6A-6D are illustrations of examples of a distribution of the columns in FIGS. 4A-5D across a plurality of storage dies and a plurality of partitions according to an embodiment;

FIG. 7 is an illustration of an example of an address offset layout according to an embodiment;

FIG. 8 is a comparative illustration of an example of a conventional die word configuration and die word configurations according to multiple embodiments;

FIGS. 9A-9B are flowcharts of examples of methods of operating a memory device according to an embodiment; and

FIG. 10 is a block diagram of an example of a performance-enhanced computing system according to an embodiment.

### DESCRIPTION OF EMBODIMENTS

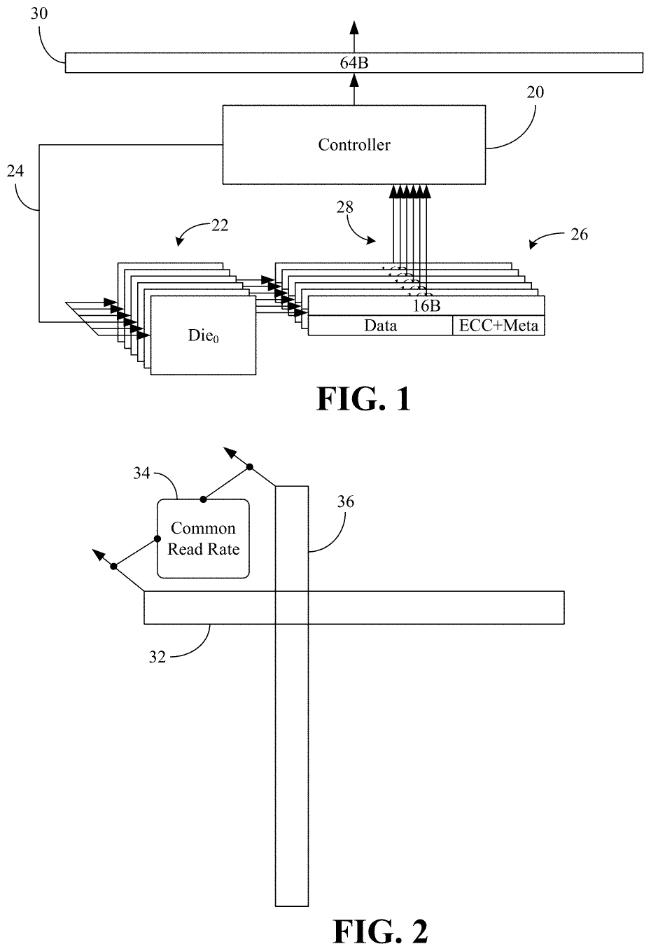

Turning now to FIG. 1, a memory layout is shown in which a controller 20 (e.g., chip controller apparatus) is coupled to a plurality of storage dies 22 (e.g., Die₀-Dieₙ₋₁) via a shared command-address (CA) bus 24. The storage dies 22 may generally include 3D memory that is arranged in a matrix that is multiple layers high, with rows and columns that intersect. When the controller 20 sends address information over the CA bus 24, die words 26 (e.g., 16B) are read from the storage dies 22 and transferred to the controller 20 via a DQ bus 28. In the illustrated example, each die word 26 includes data, error correction code (ECC) information (e.g., parity bits) and other metadata. By contrast, previous architectures may store the data and ECC parity information in dedicated dies (e.g., four dies contain data only and two dies contain ECC/meta information only). The controller 20 may decrypt the data and use the ECC information to correct the data. Once the correction is complete, clean data 30 (e.g., 64B) may be sent to a host processor (e.g., central processing unit/CPU) or other device.

As will be discussed in greater detail, the controller 20 may write the data to the storage dies 22 in a format that enables the amount of data and ECC information in each column to be variable. Thus, the number of bytes (e.g., column width) per die word 26 and strength of the ECC protection may be changed dynamically (e.g., based on the protection constraints of the application) so that different configurations within different regions of a single memory module may be achieved. Indeed, the ECC strength in row and column dimensions need not be the same. Moreover, the data format also enables column and row data to be read at equal speeds, which further enhances performance.

FIG. 2 shows a row 32 of die words that are read at a read rate 34. In the illustrated example, a column 36 of die words is also read at the read rate. Thus, the read rate 34 may be common to both the column 36 and the row 32. As will be discussed in greater detail, the common read rate 34 may be achieved by distributing the column 36 across multiple storage dies as well as across multiple partitions.

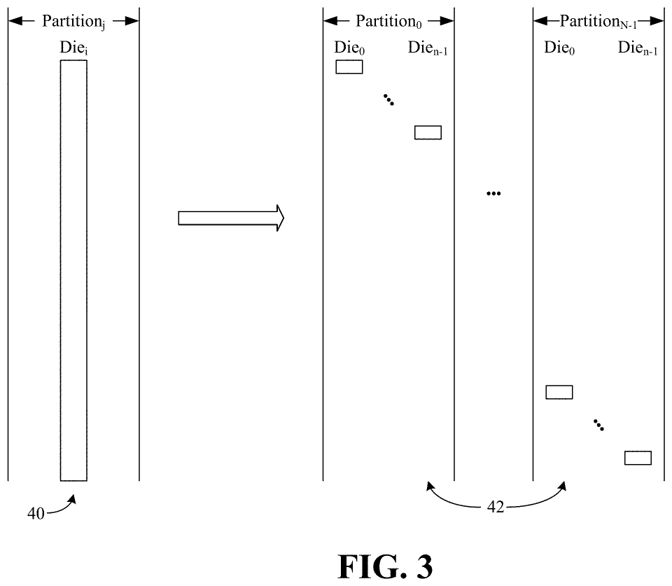

Turning now to FIG. 3, a conventional column 40 of die words is shown in which the entire conventional column 40 is written to a single storage die (Dieᵢ) and a single partition (Partitionⱼ). In an embodiment, the conventional column 40 is distributed as an enhanced column 42 across a plurality of storage dies (Die₀-Dieₙ₋₁) and a plurality of partitions (Partition₀-Partition_{N-1}). The illustrated distribution enables the enhanced column 42 to be read at the same speed as rows of the die words.

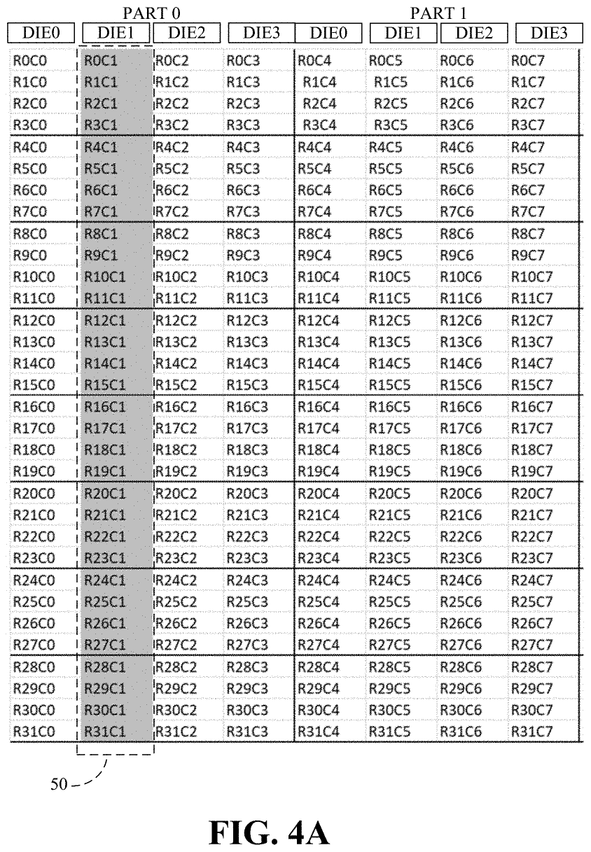

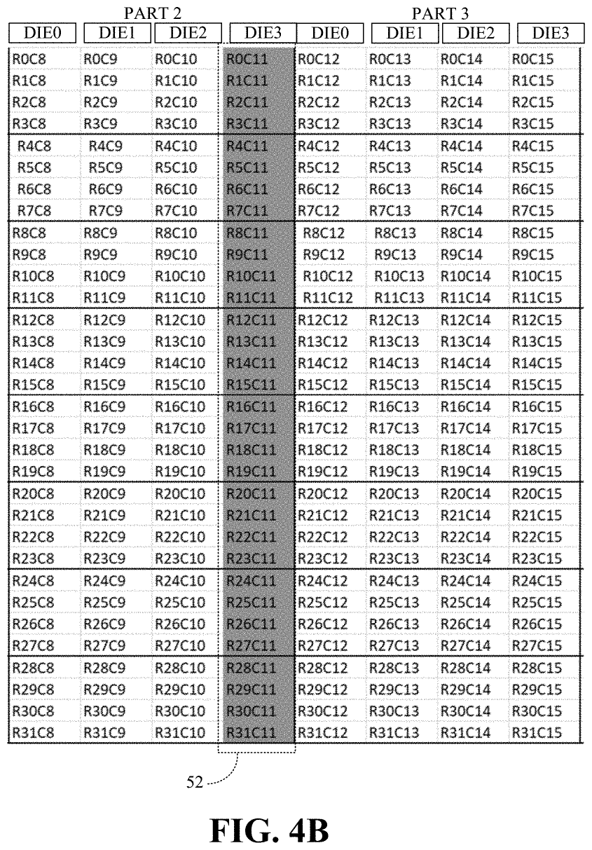

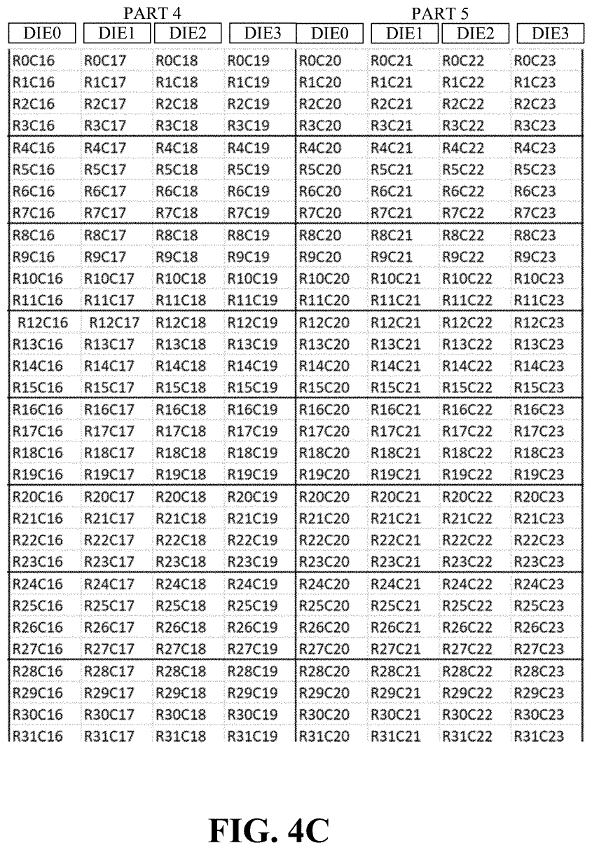

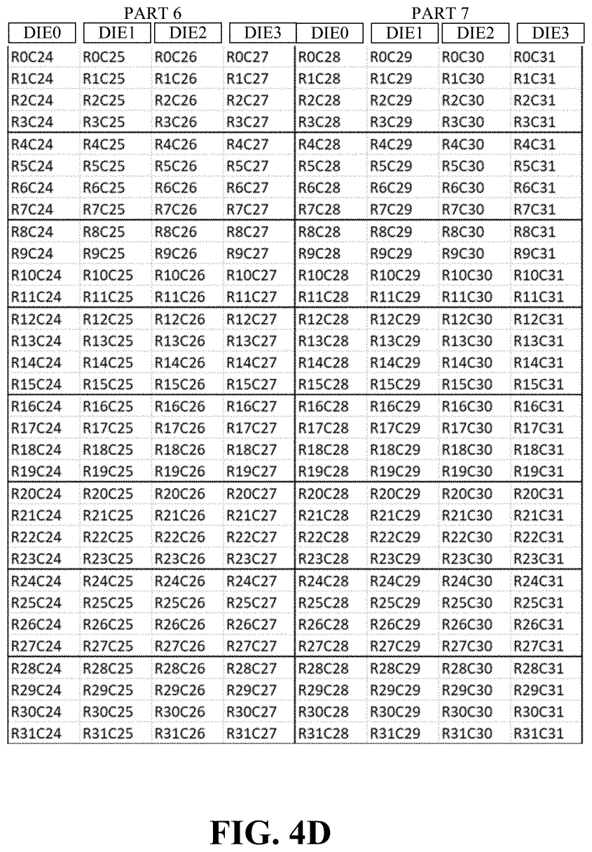

With continuing reference to FIGS. 4A-4D, an original column 50 includes die words ROC1 (row 0, column 1) through R31C1 (row 31, column 1). As best shown in FIG. 4A, the original column 50 is initially designated to be written to storage die “DIE1” and in partition “PART 0”. Similarly, FIG. 4B demonstrates that an original column 52 includes die words ROC11 (row 0, column 11) through R31C11 (row 31, column 11) and is initially designated to be written to storage die “DIE3” and in partition “PART 2”. The illustrated layout of two-dimensional (2D) data may result in relatively slow column read speeds compared to row reads.

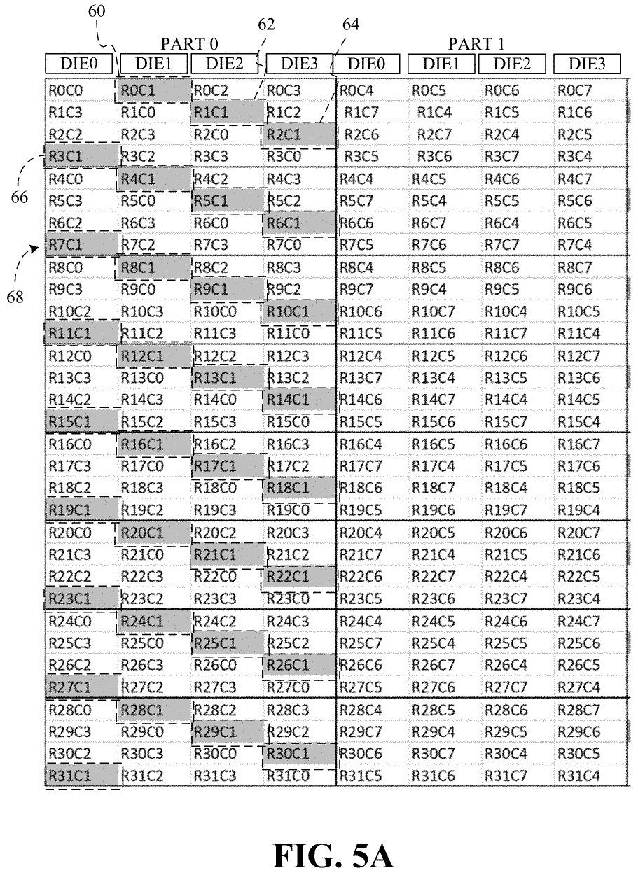

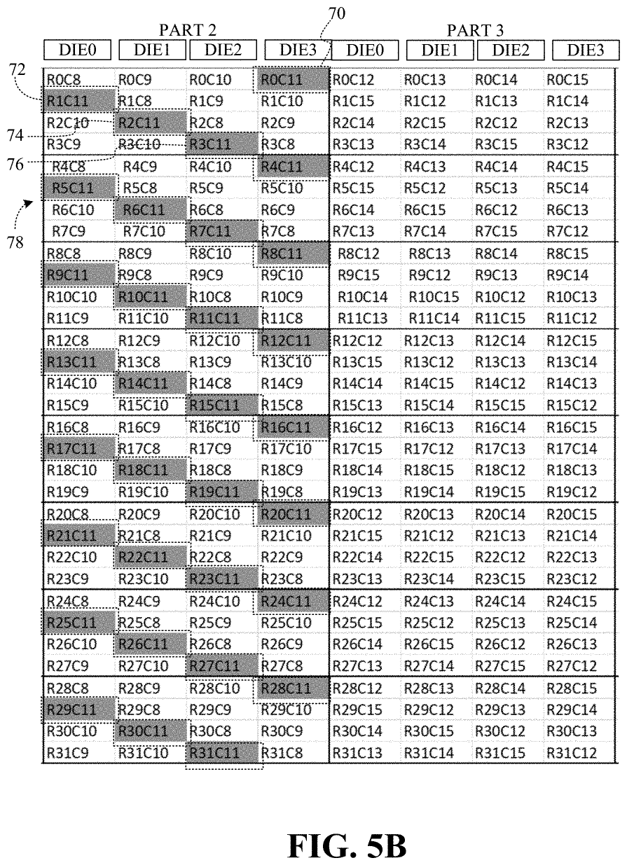

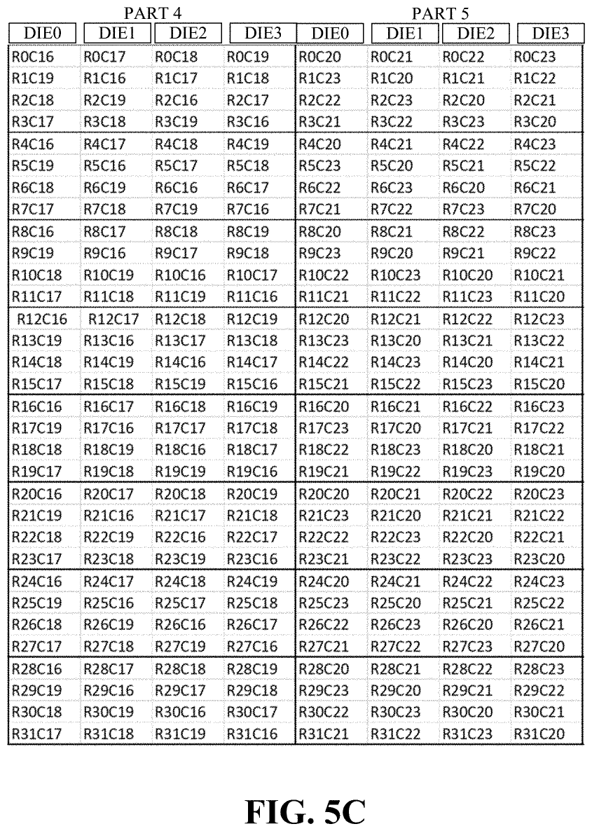

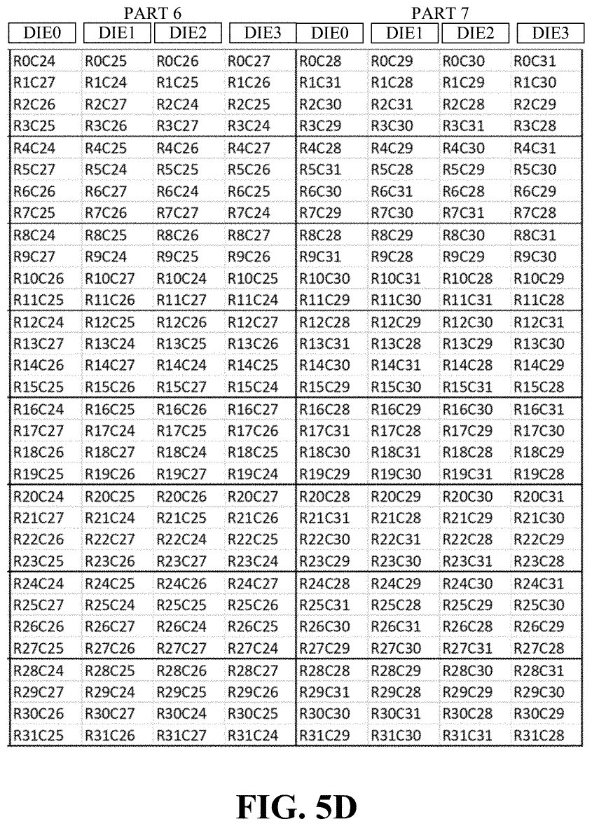

With continuing reference to FIGS. 5A-5D, the original column 50 (FIG. 4A) and the original column 52 (FIG. 4B) are distributed across a plurality of storage dies (DIE0-DIE3). As best shown in FIG. 5A, a first die word 60 remains mapped to DIE1, a second die word 62 is mapped/rotated from DIE1 to DIE2, a third die word 64 is mapped from DIE1 to DIE3, and a fourth die word 66 is mapped from DIE1 to DIE0. The illustrated mappings are intermediate mappings and do not represent write operations. Similar mappings may be conducted for another set of die words 68, and so forth.

Similarly, FIG. 5B demonstrates that a first die word 70 remains mapped to DIE3, a second die word 72 is mapped from DIE3 to DIE0, a third die word 74 is mapped from DIE3 to DIE1, and a fourth die word 76 is mapped from DIE3 to DIE2. Again, the illustrated mappings are intermediate mappings and similar mappings may be conducted for another set of die words 78, and so forth.

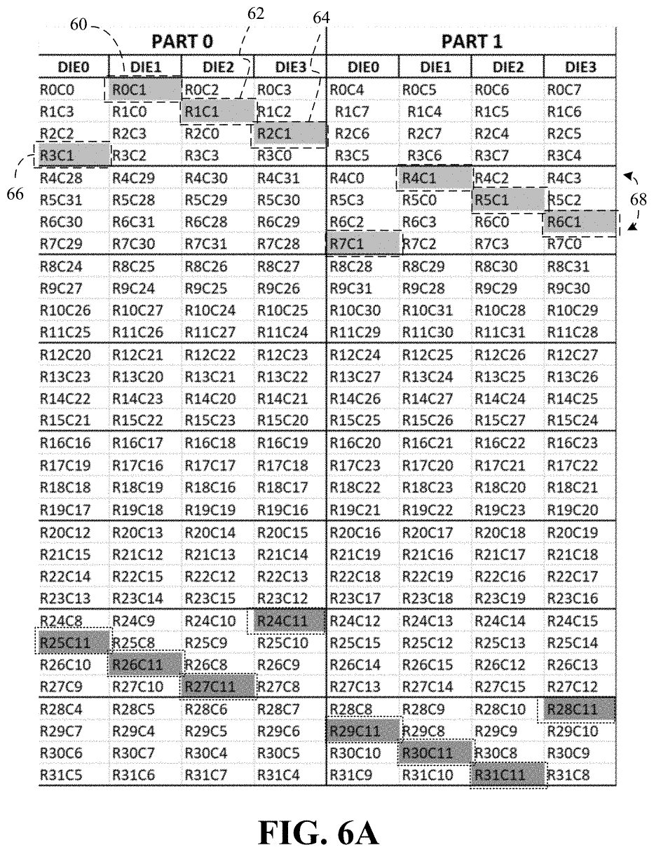

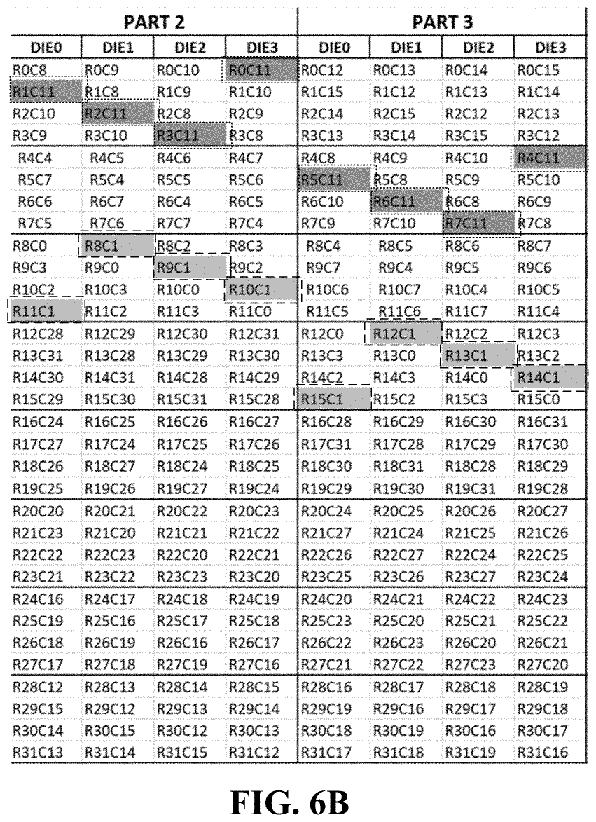

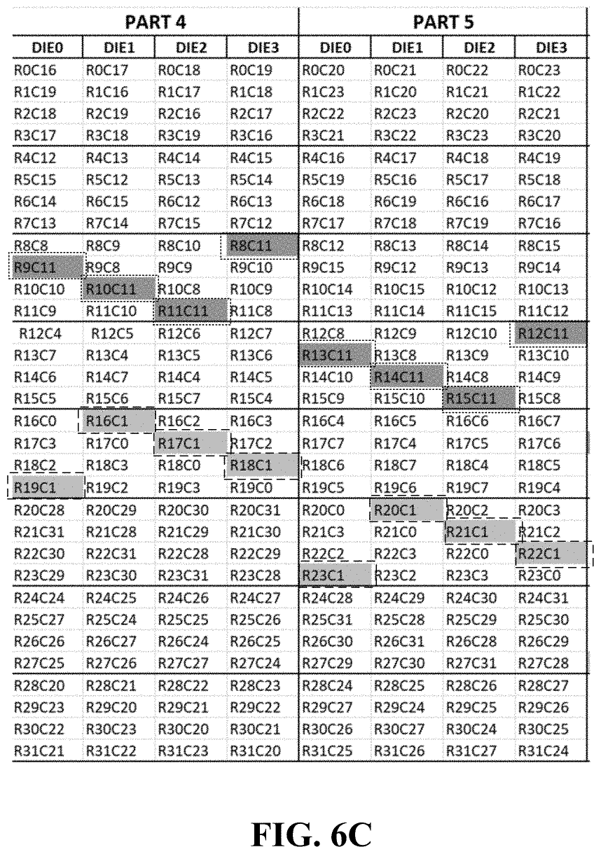

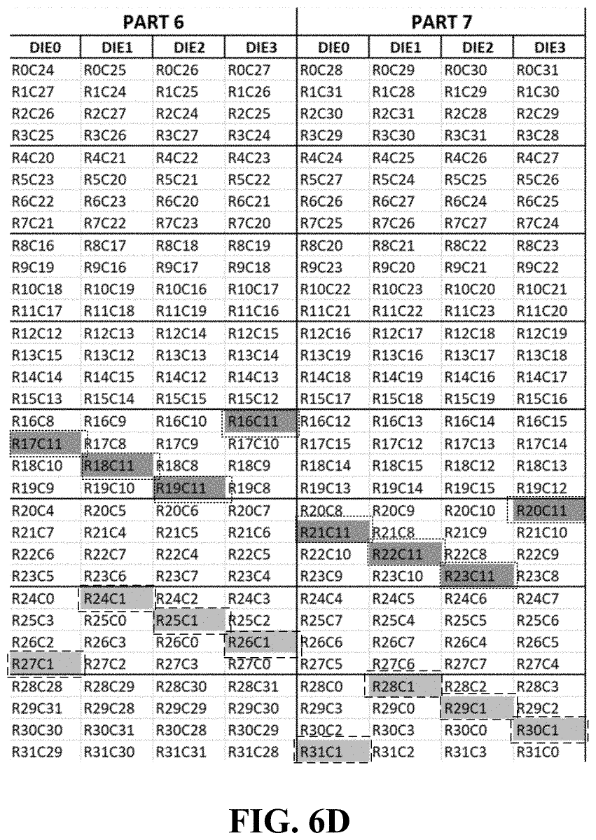

With continuing reference to FIGS. 6A-6D, the original column 50 (FIG. 4A) and the original column 52 (FIG. 4B) are distributed across a plurality of partitions (PART 0-PART 7). As best shown in FIG. 6A, the die words 60, 62, 64, 66 remain mapped to PART 0, the other set of die words 68 are mapped from PART 0 to PART 1, and so forth. In one example, the illustrated mappings are final mappings that may be used to conduct write operations. Pseudo code to automate the write layout and obtain the illustrated matrix is provided below.

Divide the matrix data in die word size columns.
die_word=bytes per address per die=16B (for current Optane)

Ensure that the number of columns (num_columns) is a multiple of num_dies//num_dies=4 in the example shown

If num_columns>num_dies*num_part then divide the matrix in separate matrices with num_dies*num_part columns, and apply the layout for each sub-matrix

For each row in the matrix:
For each sub-block of num_dies words
   Rotate right each sub_block by mod(row_id, num_dies)
Rotate right the modified row by ceil(row_id/num_dies)
Write the modified row in the same address across num_columns/num_dies partitions

Return start_address, num_columns, and num_rows

Rows

The matrix-aware row read operation will read based on row_id in the matrix and a rearrangement of the data in the correct order. Pseudo code to automate row reads is provided below.

For address=start_address+row_id
Find start_part_id=ceil(row_id/num_dies)
For part in mod(start_part_id to num_columns/num_dies, num_columns/num_dies)
   Read codeword (=num_dies*die_word size)
   Rotate left codeword by [−mod(row_id,num_dies)]
Return row containing num_columns die_words

Columns

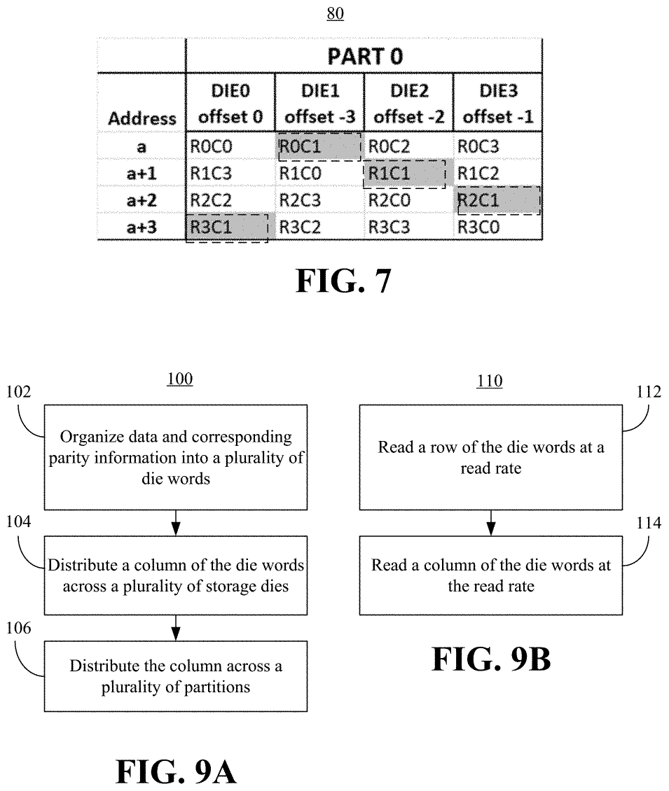

FIG. 7 demonstrates that to read columns from the illustrated data layout 80, a programmable die address offset may be used. This capability may already be present for media management tasks in current generation memories and expanded to the read columns from the data layout 80.

Die Level Address Offsets

Traditionally, all dies receive the same address on the common CA bus. To read different addresses from each die, an address offset may be stored in configuration registers on each die. Thus, for the example data layout 80, four entries/die words of column 1 can be read from four different addresses by preprogramming the address offsets as DIE0→0, DIE1→−3, DIE2→−2, DIE3→−1. Then, sending the read command on the CA bus with address “a+3” enables the four highlighted die words to be read. Note that address “a” could also be used on the CA bus, with offsets of 3, 0, 1, 2, respectively, to obtain the same result.

Column Reads

Using the per-die offset, column reads may be performed for the data layout 80 as shown in the below pseudo code.

Inputs: matrix_start_address and column_id

For each die program the die offsets as:
Offset=mod(die_id−column_id, num_dies)

Calculate start_partit_id=quotient(column_id, num_dies)

For read_id in 0 to num_columns/num_dies
part_id=mod(read_id+start_part_id, num_columns/num_dies)
address=matrix_start_address+read_id*num_dies
Read num_dies die_words from address and part_id
Rotate the die_words by [−mod(column_id,num_dies)]

Return column containing num_columns die_words

In an embodiment, the offsets are programmed again to read another column of die words.

Programmable ECC

The above technology that reads row- and column-wise data also enables the data types and the strength of ECC protection for column reads to be dynamically chosen. The technology above enables columns (and rows) consisting of die_words (e.g., 16B in size) to be read. In one example, the row data is ECC protected across all dies.

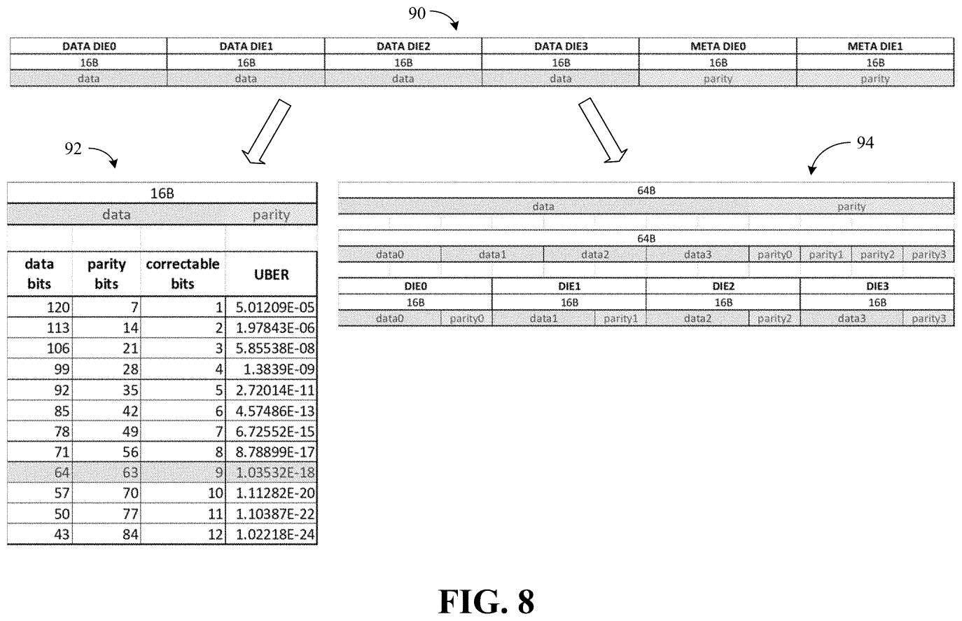

FIG. 8 demonstrates that a conventional die word configuration 90 includes the row data being 64B split across four data dies, and 32B of parity information and metadata stored at the same address in two meta dies. Thus, the ECC is valid only for the entire row, and the sub-blocks (e.g., individual die words) cannot be corrected in the illustrated approach.

Two approaches may be used to incorporate column ECC information in the layout. Both approaches allow adjusting the ECC overhead with the number of bytes per column entry. In an embodiment, the row ECC configuration using the meta dies is unchanged. Therefore, a weaker ECC protection may be chosen for columns, with occasional row reads being used to correct the data. Moreover, the column ECC choices may be tailored to each application. Indeed, even different columns within the same dataset may have different ECC protection based on requirements.

In one example, the concept of media regions is provided herein, where each region may include a block of addresses and be marked as having a particular ECC strength 1 through m. This meta information may be stored in the application so that the host is aware of which region was protected with which ECC scheme for decoding purposes later.

Option 1

A first enhanced die word configuration 92 stores the data and parity within the die words. In the illustrated example, the 16B word stored in a single die contains the data and parity bits. Accordingly, each column entry can be ECC corrected in software or a using register-transfer level (RTL) in a field-programmable gate array (FPGA) near the memory device to obtain clean columnar data. Depending on the width of data and the degree of ECC protection required, a selection may be made from a variety of data bits vs parity bits combinations. The illustrated enhanced die word configuration 92 shows the options available when using BCH (Bose-Chaudhuri-Hocquenghem) codes. Although the illustrated configuration 92 may have a relatively high ECC overhead, the configuration 92 preserves the ability to update/modify individual die words in the data.

Option 2

A second enhanced die word configuration 94 provides a more efficient approach to column ECC encoding by calculating the ECC for all dies together and saving the ECC across each die by splitting data and parity equally. The configuration 94 demonstrates a 4-die configuration with 16B available per die. The parity bits may be calculated for the entire column comprising multiple byte column entries. Afterwards, the column data and parity are split into four equal parts and stored in each die. While the configuration 94 may have a lower ECC overhead, the data write granularity increases to num_dies rows as the ECC for columns is calculated across four rows. Accordingly, individual die words cannot be updated/modified directly.

FIG. 9A shows a method 100 of operating a memory device. The method 100 may generally be implemented in a controller such as, for example, the controller 20 (FIG. 1), already discussed. More particularly, the method 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

Illustrated processing block 102 provides for organizing data and corresponding parity information into a plurality of die words. In one embodiment (e.g., Option 1), each die word includes a data block and block parity information that is dedicated to the data block. In such a case, at least two of the plurality of die words may include different amounts of the block parity information. In another embodiment (e.g., Option 2), each die word includes a portion of the data and a portion of the corresponding parity information. In such a case, at least two of the plurality of die words may include different amounts of the portion of the corresponding parity information. Block 104 distributes (e.g., rotates) a column of the die words across a plurality of storage dies. In the illustrated example, block 106 distributes the column across a plurality of partitions.

The method 100 therefore enhances performance at least to the extent that distributing the column across multiple storage dies and multiple partitions enables the number of data bytes per column die word (e.g., entry) to be variable and selected programmatically. Additionally, the width of the columns may be tuned dynamically, with different data widths in different address ranges. Embedding column ECC parity information with the column data may also enable the strength of ECC protection to be chosen dynamically, with the ECC strength potentially being different in row and column dimensions.

FIG. 9B shows a method 110 of operating a memory device. The method 110 may generally be implemented in a controller such as, for example, the controller 20 (FIG. 1), already discussed. More particularly, the method 110 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 112 reads a row of die words at a read rate, wherein block 114 reads a column of the die words at the same read rate. Speeding up the rate at which the column is read therefore further enhances performance.

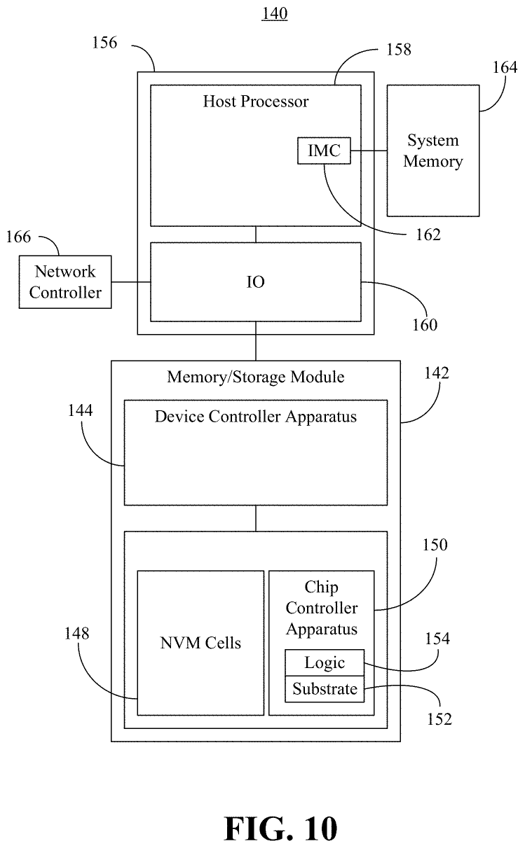

Turning now to FIG. 10, a performance-enhanced computing system 140 is shown. In the illustrated example, a memory/storage module 142 includes a device controller apparatus 144, a set of NVM cells 148, and a chip controller apparatus 150 that includes a substrate 152 (e.g., silicon, sapphire, gallium arsenide) and logic 154 (e.g., transistor array and other integrated circuit/IC components) coupled to the substrate 152. In some embodiments, the NVM cells 148 include a transistor-less stackable cross point architecture (e.g., 3D Xpoint, referred to as INTEL OPTANE) in which memory cells (e.g., sitting at the intersection of word lines and bit lines) are distributed across a plurality of storage dies and individually addressable, and in which bit storage is based on a change in bulk resistance. In an embodiment, the device controller apparatus 144 and the chip controller apparatus 150 are two parts of the same ASIC. The logic 154, which may include one or more of configurable or fixed-functionality hardware, may be configured to perform one or more aspects of the method 100 (FIG. 9A) and/or the method 110 (9B), already discussed.

Thus, the logic 154 may organize data and corresponding parity information into a plurality of die words, distribute a column of the die words across the plurality of storage dies, and distribute the column across a plurality of partitions. The logic 154 therefore enhances performance at least to the extent that distributing the column across multiple storage dies and multiple partitions enables the number of data bytes per column die word (e.g., entry) to be variable and selected programmatically. Additionally, the width of the columns may be tuned dynamically, with different data widths in different address ranges. Embedding column ECC parity information with the column data may also enable the strength of ECC protection to be chosen dynamically, with the ECC strength potentially being different in row and column dimensions.

The illustrated system 140 also includes a system on chip (SoC) 156 having a host processor 158 (e.g., central processing unit/CPU) and an input/output (TO) module 160. The host processor 158 may include an integrated memory controller 162 (IMC) that communicates with system memory 164 (e.g., RAM dual inline memory modules/DIMMs). The illustrated IO module 160 is coupled to the SSD 142 as well as other system components such as a network controller 166.

In one example, the logic 154 includes transistor channel regions that are positioned (e.g., embedded) within the substrate 152. Thus, the interface between the logic 154 and the substrate 152 may not be an abrupt junction. The logic 154 may also be considered to include an epitaxial layer that is grown on an initial wafer of the substrate 152.

### Additional Notes and Examples

Example 1 includes a semiconductor apparatus comprising one or more substrates and logic coupled to the one or more substrates, wherein the logic is implemented at least partly in one or more of configurable or fixed-functionality hardware logic, the logic coupled to the one or more substrates to organize data and corresponding parity information into a plurality of die words, distribute a column of the die words across a plurality of storage dies, and distribute the column across a plurality of partitions.

Example 2 includes the semiconductor apparatus of Example 1, wherein the logic coupled to the one or more substrates is to read a row of the die words at a read rate, and read the column of the die words at the read rate.

Example 3 includes the semiconductor apparatus of any one of Examples 1 to 2, wherein each die word is to include a data block and block parity information that is dedicated to the data block.

Example 4 includes the semiconductor apparatus of Example 3, wherein at least two of the plurality of die words are to include different amounts of the block parity information.

Example 5 includes the semiconductor apparatus of any one of Examples 1 to 2, wherein each die word is to include a portion of the data and a portion of the corresponding parity information.

Example 6 includes the semiconductor apparatus of Example 5, wherein at least two of the plurality of die words are to include different amounts of the portion of the corresponding parity information.

Example 7 includes a performance-enhanced computing system comprising a plurality of storage dies, and a controller coupled to the plurality of storage dies, wherein the controller includes logic coupled to one or more substrates, the logic to organize data and corresponding parity information into a plurality of die words, distribute a column of the die words across the plurality of storage dies, and distribute the column across a plurality of partitions.

Example 8 includes the computing system of Example 7, wherein the logic coupled to the one or more substrates is to read a row of the die words a read rate, and read the column of the die words at the read rate.

Example 9 includes the computing system of any one of Examples 7 to 8, wherein each die word is to include a data block and block parity information that is dedicated to the data block.

Example 10 includes the computing system of Example 9, wherein at least two of the plurality of die words are to include different amounts of the block parity information.

Example 11 includes the computing system of any one of Examples 7 to 8, wherein each die word is to include a portion of the data and a portion of the corresponding parity information.

Example 12 includes the computing system of Example 11, wherein at least two of the plurality of die words are to include different amounts of the portion of the corresponding parity information.

Example 13 includes at least one computer readable storage medium comprising a set of instructions, which when executed by a computing system, cause the computing system to organize data and corresponding parity information into a plurality of die words, distribute a column of the die words across a plurality of storage dies, and distribute the column across a plurality of partitions.

Example 14 includes the at least one computer readable storage medium of Example 13, wherein the instructions, when executed, further cause the computing system to read a row of the die words at a read rate, and read the column of the die words at the read rate.

Example 15 includes the at least one computer readable storage medium of any one of Examples 13 to 14, wherein each die word is to include a data block and block parity information that is dedicated to the data block.

Example 16 includes the at least one computer readable storage medium of Example 15, wherein at least two of the plurality of die words are to include different amounts of the block parity information.

Example 17 includes the at least one computer readable storage medium of any one of Examples 13 to 14, wherein each die word is to include a portion of the data and a portion of the corresponding parity information.

Example 18 includes the at least one computer readable storage medium of Example 17, wherein at least two of the plurality of die words are to include different amounts of the portion of the corresponding parity information.

Example 19 includes a method of operating a performance-enhanced computing system, the method comprising organizing data and corresponding parity information into a plurality of die words, distributing a column of the die words across a plurality of storage dies, and distributing the column across a plurality of partitions.

Example 20 includes the method of Example 19, further including reading a row of the die words at a read rate, and reading the column of the die words at the read rate.

Technology described herein therefore provides a method to read column and row data at equal speeds in OPTANE memories, where the column width (e.g., number of data bytes per entry), and strength of the ECC protection can be changed dynamically. The technology also enables different configurations within different regions of a single OPTANE memory module. Additionally, the technology may avoid costly circuit changes inside the storage die.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus comprising:
one or more substrates; and
logic coupled to the one or more substrates, wherein the logic is implemented at least partly in one or more of configurable or fixed-functionality hardware logic, the logic coupled to the one or more substrates to:
organize data and corresponding parity information into a plurality of die words;
distribute a column of the die words across a plurality of storage dies; and
distribute the column across a plurality of partitions.

2. The semiconductor apparatus of claim 1, wherein the logic coupled to the one or more substrates is to:
read a row of the die words at a read rate; and
read the column of the die words at the read rate.

3. The semiconductor apparatus of claim 1, wherein each die word is to include a data block and block parity information that is dedicated to the data block.

4. The semiconductor apparatus of claim 3, wherein at least two of the plurality of die words are to include different amounts of the block parity information.

5. The semiconductor apparatus of claim 1, wherein each die word is to include a portion of the data and a portion of the corresponding parity information.

6. The semiconductor apparatus of claim 5, wherein at least two of the plurality of die words are to include different amounts of the portion of the corresponding parity information.

7. A computing system comprising:
a plurality of storage dies; and
a controller coupled to the plurality of storage dies, wherein the controller includes logic coupled to one or more substrates, the logic to:
organize data and corresponding parity information into a plurality of die words,
distribute a column of the die words across the plurality of storage dies, and
distribute the column across a plurality of partitions.

8. The computing system of claim 7, wherein the logic coupled to the one or more substrates is to:
read a row of the die words a read rate, and
read the column of the die words at the read rate.

9. The computing system of claim 7, wherein each die word is to include a data block and block parity information that is dedicated to the data block.

10. The computing system of claim 9, wherein at least two of the plurality of die words are to include different amounts of the block parity information.

11. The computing system of claim 7, wherein each die word is to include a portion of the data and a portion of the corresponding parity information.

12. The computing system of claim 11, wherein at least two of the plurality of die words are to include different amounts of the portion of the corresponding parity information.

13. At least one computer readable storage medium comprising a set of instructions, which when executed by a computing system, cause the computing system to:
organize data and corresponding parity information into a plurality of die words;
distribute a column of the die words across a plurality of storage dies; and
distribute the column across a plurality of partitions.

14. The at least one computer readable storage medium of claim 13, wherein the instructions, when executed, further cause the computing system to:
read a row of the die words at a read rate; and
read the column of the die words at the read rate.

15. The at least one computer readable storage medium of claim 13, wherein each die word is to include a data block and block parity information that is dedicated to the data block.

16. The at least one computer readable storage medium of claim 15, wherein at least two of the plurality of die words are to include different amounts of the block parity information.

17. The at least one computer readable storage medium of claim 13, wherein each die word is to include a portion of the data and a portion of the corresponding parity information.

18. The at least one computer readable storage medium of claim 17, wherein at least two of the plurality of die words are to include different amounts of the portion of the corresponding parity information.

19. A method comprising:
organizing data and corresponding parity information into a plurality of die words;
distributing a column of the die words across a plurality of storage dies; and
distributing the column across a plurality of partitions.

20. The method of claim 19, further including:
reading a row of the die words at a read rate; and
reading the column of the die words at the read rate.
